(19) United States
(12) Patent Application Publication
(10) Pub. No.: US 2018/0335988 A1
(43) Pub. Date: Nov. 22, 2018

(54) IMAGE FORMING APPARATUS, METHOD OF CONTROLLING SAME, AND STORAGE MEDIUM

(71) Applicant: CANON KABUSHIKI KAISHA, Tokyo (JP)

(72) Inventor: Masumi Tabuki, Toride-shi (JP)

(21) Appl. No.: 15/981,050

(22) Filed: May 16, 2018

(30) Foreign Application Priority Data
May 17, 2017 (JP) 2017-098411

(51) Int. Cl. G06F 3/12

(52) U.S. Cl. CPC G06F 3/1235; G06F 3/1273; G06F 3/1259; G06F 3/1219

(57) ABSTRACT

A technique that enables identification, based on history information and not depending on date/time information, of a toner cartridge used when an error occurred in an image forming apparatus is provided. A CPU of the image forming apparatus counts a cumulative number of print sheets from a time of factory shipment of the image forming apparatus. If replacement of a toner cartridge mounted to the image forming apparatus is performed, the CPU saves a cartridge replacement history that includes information relating to the toner cartridge after the replacement. If an error occurs in the image forming apparatus, the CPU saves an error history that includes the cumulative number of print sheets for when the error occurred. A cumulative number of print sheets for when the replacement was performed is included in the cartridge replacement history.

### BACKGROUND OF THE INVENTION

### Field of the Invention

The present invention relates to an image forming apparatus, a method of controlling the same, and a storage medium.

### Description of the Related Art

In an image forming apparatus, information relating to an error such as a sheet jam and information relating to an operation for replacing a consumable such as a toner cartridge (a toner container) is often saved as history information for utilization in maintenance and error recovery of an apparatus. For example, in Japanese Patent Laid-Open No. 2010-152562, log information such as a status and a date/time when an error occurred can be stored in a non-volatile memory, and the log information can be displayed at a time of maintenance, for example.

In addition, in recent years, from a perspective of environment protection, there are case where a toner cartridge that has been fully used once is subject to a refill of toner and thus reused. However, if refilling of toner is performed for a toner cartridge for which reuse was originally not envisioned, there is the possibility that a problem such as toner leakage or print failure will occur. With respect to such problems, Japanese Patent Laid-Open No. 2004-202753 proposes a method for distinguishing a usage history for an authentic product toner cartridge from usage history an inauthentic product toner cartridge, and managing them as history information.

However, in the aforementioned conventional technique, in an image forming apparatus that does not have an RTC (real-time clock), there are cases where it is not possible to use date/time information included in history information to correctly identify a toner cartridge that was used (mounted) when an error occurred. Accordingly, it is necessary to be able to identify, based on history information, a toner cartridge that was used when an error occurred without depending on date/time information.

### SUMMARY OF THE INVENTION

The present invention was conceived in view of the above described issues. The present invention provides a technique that enables identification, based on history information and not depending on date/time information, of a toner cartridge (a toner container) used when an error occurred in an image forming apparatus.

According to one aspect of the present invention, there is provided an image forming apparatus comprising: an image forming unit that forms an image on a sheet by using toner contained in a container mounted to the image forming apparatus; a memory device that stores a set of instructions; and at least one processor that executes the set of instructions to: count a cumulative number from a time of factory shipment of the image forming apparatus, that is a cumulative number of sheets to which image formation by the image forming unit has been performed; in a case where a replacement of the container mounted to the image forming apparatus is performed, save a replacement history that includes the cumulative number for when the replacement was performed and information relating to a container after the replacement; and in a case where an error occurs in the image forming apparatus, save an error history that includes the cumulative number for when the error occurred.

According to another aspect of the present invention, there is provided a method of controlling an image forming apparatus, the method comprising: forming an image on a sheet by using toner contained in a container mounted to the image forming apparatus; counting a cumulative number from a time of factory shipment of the image forming apparatus that is a cumulative number of sheets to which image formation is performed; in a case where a replacement of the container mounted to the image forming apparatus is performed, saving a replacement history that includes the cumulative number for when the replacement was performed and information relating to a container after the replacement; and in a case where an error occurs in the image forming apparatus, saving an error history that includes the cumulative number for when the error occurred.

According to still another aspect of the present invention, there is provided a non-transitory computer-readable storage medium storing a computer program for causing a computer to execute a method of controlling an image forming apparatus, the method comprising: forming an image on a sheet by using toner contained in a container mounted to the image forming apparatus; counting a cumulative number from a time of factory shipment of the image forming apparatus that is a cumulative number of sheets to which image formation is performed; in a case where a replacement of the container mounted to the image forming apparatus is performed, saving a replacement history that includes the cumulative number for when the replacement was performed and information relating to a container after the replacement; and in a case where an error occurs in the image forming apparatus, saving an error history that includes the cumulative number for when the error occurred.

By virtue of the present invention, it is possible to identify, based on history information and not depending on date/time information, a toner cartridge used when an error occurred in an image forming apparatus.

Further features of the present invention will become apparent from the following description of exemplary embodiments (with reference to the attached drawings).

### BRIEF DESCRIPTION OF THE DRAWINGS

FIG. 1 is a block diagram that illustrates a hardware configuration of an image forming apparatus 10.

FIG. 2 is a block diagram which illustrates an example of a controller 2.

FIG. 3A and FIG. 3B illustrate an example of an error history and a cartridge replacement history.

FIG. 4 is a flowchart for describing a procedure of processing performed at a time of printing in the image forming apparatus 10.

FIG. 5 is a flowchart for describing a procedure of processing performed when an error occurs in the image forming apparatus 10.

FIG. 6 is a flowchart for describing a procedure of processing performed when a toner cartridge is replaced in the image forming apparatus 10.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Hardware Configuration of Image Forming Apparatus>

FIG. 1 is a block diagram that illustrates an example of a hardware configuration of an image forming apparatus 10 which is an image forming apparatus according to an embodiment of the present invention. The image forming apparatus 10 is provided with a scanner 1, a controller 2, a printer 3, an operation unit 4, a toner cartridge 5 (a toner container), and a cartridge sensor 8. The toner cartridge 5 is provided with a toner remaining amount sensor 6 and a flash memory 7.

The controller 2 controls the scanner 1, the printer 3, and the operation unit 4 to thereby control the entirety of the image forming apparatus 10. The controller 2 controls operations of the scanner 1 and the printer 3 based on an instruction inputted via the operation unit 4, or an instruction received from an external apparatus via a network. Accordingly, various functions of the image forming apparatus 10, such as a copy function, a scanning function, and a printing function, are realized.

The scanner 1 is provided with an optical unit (for example, a CCD image sensor), and, by irradiating light onto an original and optically reading an image of the original, generates image data corresponding to the image. The toner cartridge 5 is detachably mounted to the printer 3. The printer 3 uses toner contained in the toner cartridge 5 to form an image on a sheet, based on image data received from the controller 2. The controller 2 can detect, by the cartridge sensor 8, the toner cartridge 5 mounted in the image forming apparatus 10. The controller 2 uses the cartridge sensor 8 to determine whether or not the toner cartridge 5 is mounted.

The toner cartridge 5 is provided with the toner remaining amount sensor 6. The toner remaining amount sensor 6 can detect a remaining amount of toner in the toner cartridge 5. The controller 2 can obtain information indicating the remaining amount of toner from the toner remaining amount sensor 6. The toner cartridge 5 is further provided with a flash memory 7 which is a non-volatile memory. Identification information of the toner cartridge 5 and information indicating a usage history of the toner cartridge 5 are stored in the flash memory 7. The information indicating the usage history can include identification information of the image forming apparatus in which the toner cartridge 5 has been mounted (has performed printing using toner in the toner cartridge 5), and flag information indicating whether or not the toner cartridge 5 has had a toner outage. A state of a toner outage is a so-called out of toner state, and is a state where a remaining amount of toner in the toner cartridge 5 is 0 or an amount close to 0.

The operation unit 4 is equipped with a keyboard, a touch panel, or the like as an input device, and is equipped with a liquid crystal display or the like as a display device. The controller 2 displays, on the operation unit 4, the existence or absence of the occurrence of an error in the image forming apparatus 10, and information relating to control of a function that the image forming apparatus 10 has, such as the scanning function or the copy function. In addition, the controller 2 can accept an instruction from a user via the operation unit 4.

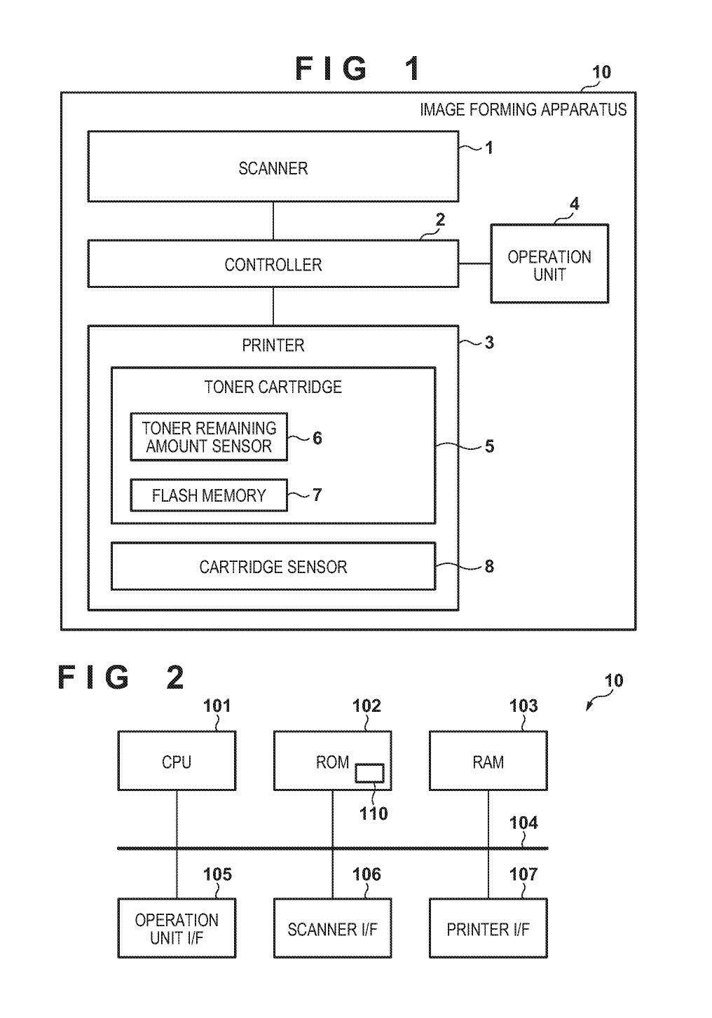

FIG. 2 is a block diagram that illustrates an example of a hardware configuration of the controller 2 of the image forming apparatus 10 of the present embodiment. The controller 2 is provided with a CPU 101, a ROM 102, a RAM 103, an operation unit interface (I/F) 105, a scanner I/F 106, and a printer I/F 107, and comprehensively controls each device connected to the system bus 104.

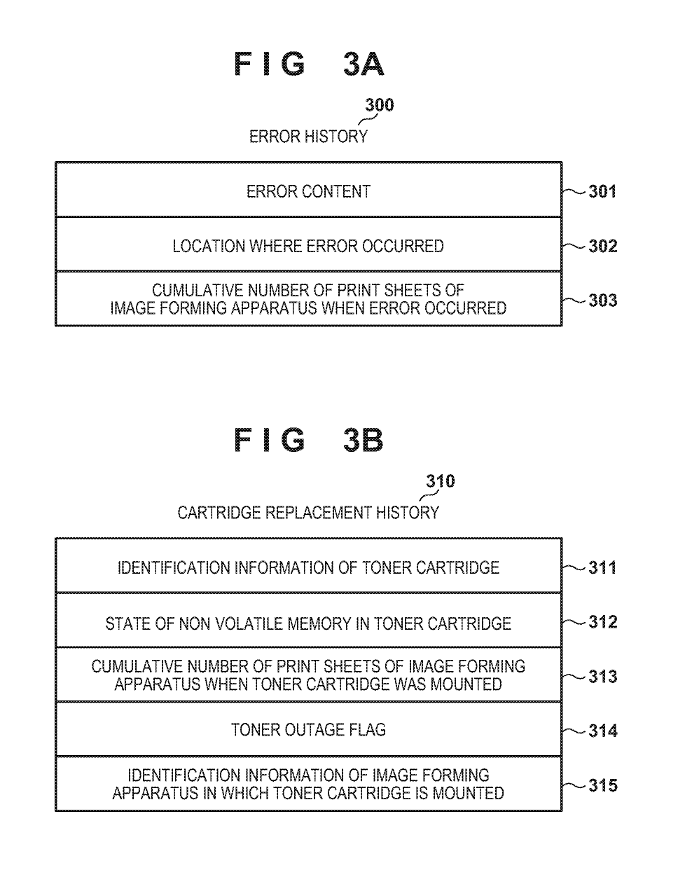

The CPU 101 controls operation of the image forming apparatus 10 as a whole by reading a program stored in the ROM 102 and executing it. The ROM 102 stores various fonts used in display, printing or the like in the image forming apparatus 10, and various control programs or the like that are executed by the CPU 101. The ROM 102 is also provided with an NVRAM (non-volatile RAM) region 110. In the present embodiment, various information such as an error history 300 (FIG. 3A), a cartridge replacement history 310 (FIG. 3B), and a count value for a cumulative number of print sheets from a time of shipment from a factory can be held in the NVRAM region 110. The RAM 103 is used as a main memory, a work area, or the like of the CPU 101, and is also used as a primary storage region for image information.

The operation unit I/F 105 functions as an I/F with respect to the operation unit 4, and controls the operation unit 4. The scanner I/F 106 functions as an I/F with respect to the scanner 1, and controls the scanner 1. The printer I/F 107 functions as an I/F with respect to the printer 3. It manages errors that occur in the printer 3 and a state of the toner cartridge 5.

<Error History>

FIG. 3A illustrates an example of error history 300 that is held in the NVRAM region 110 of the ROM 102 in the image forming apparatus 10. The error history 300 includes a plurality of items 301 through 303 as illustrated in FIG. 3A, and is generated and stored (saved) in the NVRAM region 110 each time an error occurs in the image forming apparatus 10. Accordingly, the image forming apparatus 10 can hold in the NVRAM region 110 a plurality of error histories 300 that are generated each time an error occurs. The items 301 through 303 of the error history 300 are information that enables detail of the content of an error that occurred in the image forming apparatus 10 to be grasped, as described below.

The item 301 is information that indicates the content of an error that occurred in the image forming apparatus 10. Errors that can occur in the image forming apparatus 10 include a sheet jam and defective fixing. The item 301 is, for example, an error code that enables unique identification of an error that has occurred. The item 302 is information indicating a location where the error occurred in the image forming apparatus 10, and is location information that enables unique identification of the location where the error occurred. The item 303 is a cumulative number of print sheets of the image forming apparatus 10 when the error occurred. The cumulative number of print sheets is a cumulative number of sheets to which image formation (printing) has been performed, from a time of shipment from a factory of the image forming apparatus 10. The CPU 101 of the image forming apparatus 10 counts the cumulative number of print sheets and holds a count value for the cumulative number in the NVRAM region 110. The count value held in the NVRAM region 110 when an error occurs is stored in the item 303.

<Cartridge Replacement History>

FIG. 3B illustrates an example of a cartridge replacement history 310 that is held in the NVRAM region 110 of the ROM 102 in the image forming apparatus 10. The cartridge replacement history 310 includes a plurality of items 311 through 315 as illustrated in FIG. 3B, and is generated and saved in the NVRAM region 110 each time the toner cartridge 5 mounted in the image forming apparatus 10 is replaced. Accordingly, the image forming apparatus 10 can hold in the NVRAM region 110 a plurality of cartridge replacement histories 310 that are generated each time the toner cartridge 5 is replaced. The items 311 through 315 of the cartridge replacement history 310 is, as described below, information that enables usage history of the toner cartridge 5 which has been replaced to be grasped in detail.

The item 311 is identification information of the toner cartridge 5 that is stored in the flash memory 7 of the toner cartridge 5 in advance. The item 312 is memory state information that indicates a state of the flash memory 7 of the toner cartridge 5. The memory state information indicates whether or not read and write (R/W) are possible with respect to the flash memory 7, and is set to information indicating “normal” in a case where these are possible, and is set to information indicating “abnormal” in a case where these are not possible. The item 313 is a cumulative number of print sheets of the image forming apparatus 10 for when the toner cartridge 5 was mounted to the image forming apparatus 10 (when replacement with the toner cartridge 5 was performed).

The item 314 is a toner outage flag indicating whether the toner cartridge 5 has entered an out of toner state. The toner outage flag is set in advance to “OFF” which indicates that the toner cartridge 5 has not been out of toner, and is stored in the flash memory 7 in the toner cartridge 5. When out of toner is detected by the toner remaining amount sensor 6 in a state where the toner cartridge 5 is mounted to the image forming apparatus 10, the toner outage flag is set to “ON” which indicates that the toner cartridge 5 has been out of toner. The toner outage flag indicates whether or not the toner cartridge 5 has been out of toner in the past even once, and is an example of information indicating usage history of the toner cartridge 5. It is possible to determine that the toner cartridge 5 has been refilled with toner if the toner outage flag is ON and the toner cartridge 5 has ceased to be in the out of toner state after being out of toner. Whether or not toner has been refilled may be included in the usage history of the toner cartridge 5.

The item 315 is identification information for an image forming apparatus to which the toner cartridge 5 was mounted in the past. This information is stored in the flash memory 7 of the toner cartridge 5, is information that enables identification of an image forming apparatus for which mounting of the toner cartridge 5 thereto was detected in the past by the cartridge sensor 8, and is an example of information that indicates a usage history of the toner cartridge 5.

<Processing at Time of Printing>

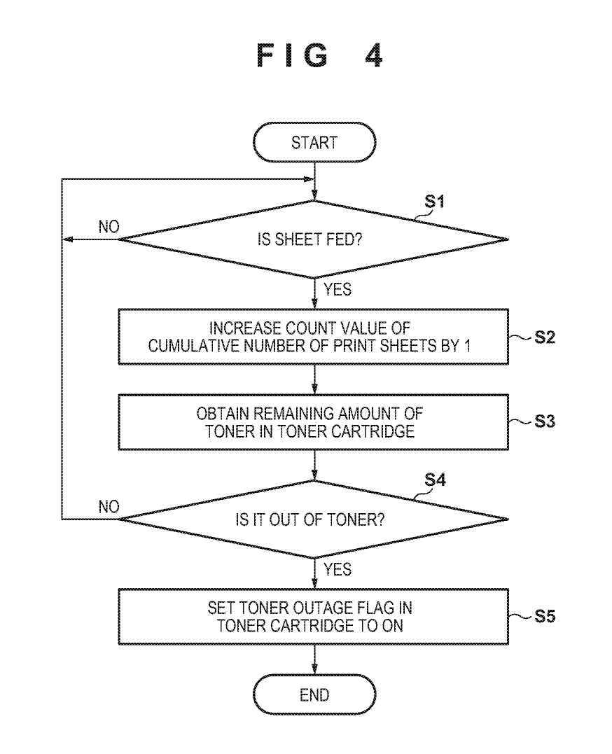

FIG. 4 is a flowchart for describing a procedure of processing performed at a time of printing in the image forming apparatus 10. The processing of each step of FIG. 4 is realized in the image forming apparatus 10 by the CPU 101 reading a control program stored in the ROM 102 and executing it.

If execution of a job for performing printing to a sheet is started in the image forming apparatus 10, in step S1 the CPU 101 determines whether or not the sheet which is a printing target has been fed from a feeding unit. The CPU 101 advances the processing from step S1 to S2 each time one sheet is fed. In step S2, the CPU 101 increases by 1 a count value, which is held in the NVRAM region 110 of the ROM 102, of the cumulative number of print sheets from the time of shipment from a factory of the image forming apparatus 10.

In this way, in the present embodiment, the CPU 101 counts the cumulative number of print sheets from the time of shipment from a factory of the image forming apparatus 10 by causing the count value for the cumulative number of print sheets to increase by 1 each time one sheet is fed. The cumulative number of print sheets held in the NVRAM region 110 is initialized to 0 before factory shipping, and is set so that initialization cannot be performed after the factory shipping.

Next, in step S3, the CPU 101 obtains a detection result for a remaining amount of toner in the toner cartridge 5 from the toner remaining amount sensor 6 in the toner cartridge 5. Additionally, in step S4, the CPU 101 determines whether or not an out of toner state has been entered, based on the obtained detection result. The CPU 101 returns the processing to step S1 if not out of toner, and advances the processing to step S5 if the out of toner state has been entered.

In step S5, the CPU 101 sets the toner outage flag which is held in the flash memory 7 in the toner cartridge 5 to “ON”. Accordingly, the CPU 101 stores flag information that indicates that the toner cartridge 5 has entered the out of toner state in the flash memory 7 of the toner cartridge 5 mounted to the image forming apparatus 10. Subsequently, the CPU 101 ends the processing.

<Processing when Error Occurs>

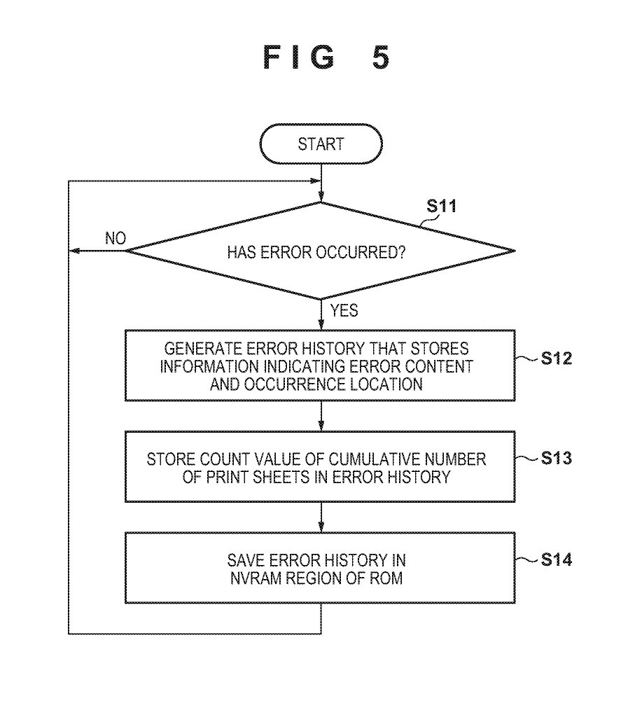

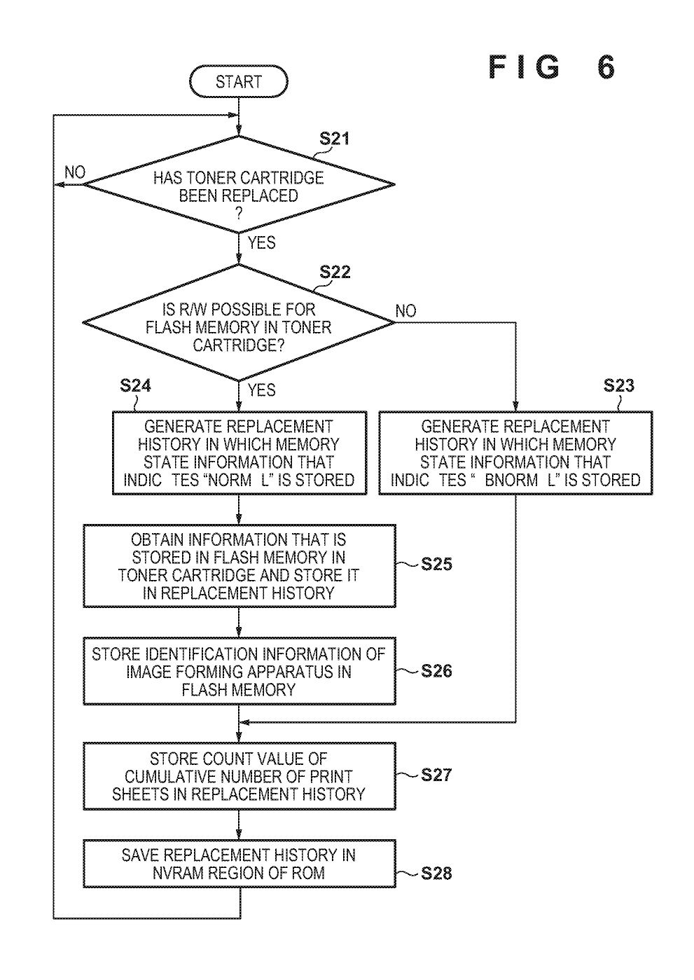

FIG. 5 is a flowchart for describing a procedure of processing performed when an error occurs in the image forming apparatus 10. The processing of each step of FIG. 5 is realized in the image forming apparatus 10 by the CPU 101 reading a control program stored in the ROM 102 and executing it. The processing of FIG. 5 is executed while the image forming apparatus 10 has been activated.

First, in step S11 the CPU 101 determines whether or not an error such as a sheet jam has occurred. The CPU 101 repeats the determination of step S11 if an error has not occurred, and advances the processing to step S12 if an error has occurred. In other words, the processing of step S12 through step S14 is performed each time an error occurs in the image forming apparatus 10.

In step S12, the CPU 101 generates an error history 300 that stores information indicating content and an occurrence location of the error that occurred in the image forming apparatus 10. Furthermore, in step S13, the CPU 101 stores, in the generated error history 300, the cumulative number of print sheets (in other words, the cumulative number of print sheets when the error occurred) held in the NVRAM region 110. Subsequently, in step S14, the CPU 101 saves the generated error history 300 in the NVRAM region 110, and returns the processing to step S11.

<Processing for Time Replacing Toner Cartridge>

FIG. 6 is a flowchart illustrating a procedure for processing performed when the toner cartridge 5 in the image forming apparatus 10 is replaced. The processing of each step of FIG. 6 is realized in the image forming apparatus 10 by the CPU 101 reading a control program stored in the ROM 102 and executing it. The processing of FIG. 6 is executed while the image forming apparatus 10 has been activated.

Firstly, in step S21, the CPU 101 determines whether or not the toner cartridge 5 has been replaced based on a detection result for the toner cartridge 5 in accordance with the cartridge sensor 8. The CPU 101 repeats the determination of step S21 if the toner cartridge 5 has not been replaced, and advances the processing to step S22 if the toner cartridge 5 has been replaced. In other words, the processing of step S22 through step S28 is performed each time the toner cartridge 5 is replaced.

In step S22, the CPU 101 determines whether or not read and write (R/W) with respect to the flash memory 7 of the toner cartridge 5 after replacement are possible (in other words, whether or not they can be normally performed). The CPU 101 advances the processing to step S23 if read and write with respect to the flash memory 7 cannot be normally performed, and advances the processing to step S24 if they can be performed normally.

In step S23, the CPU 101 generates a cartridge replacement history 310 that stores memory state information indicating “abnormal”, and advances the processing to step S27. Meanwhile, in step S24, the CPU 101 generates a cartridge replacement history 310 that stores memory state information indicating “normal”, and advances the processing to step S25. Note that the memory state information is stored in the item 312 of the cartridge replacement history 310.

In step S25, the CPU 101 obtains information stored in the flash memory 7 of the toner cartridge 5 after replacement and stores this information in the generated cartridge replacement history 310. Specifically, the CPU 101 reads, from the flash memory 7, identification information of the image forming apparatus to which the toner cartridge 5 after the replacement has been mounted in the past, as well as the toner outage flag and the identification information of the toner cartridge 5 after the replacement. Furthermore, the CPU 101 respectively stores read information in the items 311, 314, and 315 of the cartridge replacement history 310.

Next, in step S26, the CPU 101 stores, in the flash memory 7 of the toner cartridge 5 after the replacement, identification information (for example, a main body serial number) of the self-apparatus (the image forming apparatus 10) that is held in the ROM 102, and advances the processing to step S27. This identification information is held in the flash memory 7 as information indicating the image forming apparatus to which the toner cartridge 5 after the replacement was mounted in the past.

In step S27, the CPU 101 stores, in the cartridge replacement history 310, the cumulative number of print sheets held in the NVRAM region 110 of the ROM 102. In other words, it is stored in the cartridge replacement history 310 as the cumulative number of print sheets for when the toner cartridge 5 after the replacement was mounted to the image forming apparatus 10 (for when replacement of the toner cartridge 5 was performed). The cumulative number of print sheets is stored in the item 313 of the cartridge replacement history 310. The cumulative number of print sheets stored in the cartridge replacement history 310 can be used as information for identifying a toner cartridge (a toner container) that was mounted when an error occurred in the image forming apparatus 10. Subsequently, in step S28, the CPU 101 saves the generated the cartridge replacement history 310 in the NVRAM region 110, and returns the processing to step S21.

As described above, in the image forming apparatus 10 of the present embodiment, the CPU 101 counts a cumulative number of print sheets from the time of shipment from a factory of the image forming apparatus 10, which is the cumulative number of sheets (cumulative number of print sheets) for which image formation (printing) has been performed by the printer 3. If replacement of a toner cartridge mounted to the image forming apparatus 10 is performed, the CPU 101 saves the cartridge replacement history 310 that includes information relating to the toner cartridge after the replacement in the NVRAM region 110. If an error occurs in the image forming apparatus 10, the CPU 101 saves in the NVRAM region 110 an error history that includes the cumulative number of print sheets for when the error occurred. Furthermore, in a case of saving the cartridge replacement history 310, the CPU 101 includes and saves in the cartridge replacement history 310 a cumulative number of print sheets for when the replacement was performed as information for identifying the toner cartridge that was mounted when the error occurred.

Accordingly, by comparing the cumulative numbers of print sheets included in the error history 300 and the cartridge replacement history 310 that are saved in the NVRAM region 110, it is possible to identify the toner cartridge that was used (mounted) when an error occurred in the image forming apparatus 10. Accordingly, it is possible to identify a toner cartridge used when an error occurred without depending on an RTC (in other words, without depending on date/time information).

In addition, it is possible to grasp a usage history of the toner cartridge based on identification information of the image forming apparatus to which the toner cartridge was mounted in the past and a toner outage flag, that are included in the cartridge replacement history 310 for the identified toner cartridge. Accordingly, it is possible to distinguish between whether the cause of an error that occurred in the image forming apparatus 10 is due to the image forming apparatus 10 and whether it is due to the toner cartridge that was mounted when the error occurred.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-98411, filed May 17, 2017, which is hereby incorporated by reference herein in its entirety.

What is claimed is:

1. An image forming apparatus comprising:
an image forming unit that forms an image on a sheet by using toner contained in a container mounted to the image forming apparatus;
a memory device that stores a set of instructions; and
at least one processor that executes the set of instructions to:
count a cumulative number from a time of factory shipment of the image forming apparatus, that is a cumulative number of sheets to which image formation by the image forming unit has been performed;
in a case where a replacement of the container mounted to the image forming apparatus is performed, save a replacement history that includes the cumulative number for when the replacement was performed and information relating to a container after the replacement; and
in a case where an error occurs in the image forming apparatus, save an error history that includes the cumulative number for when the error occurred.

2. The image forming apparatus according to claim 1, wherein the at least one processor executes instructions in the memory device to
include, in the replacement history, information that indicates a usage history of the container and that is stored in a memory equipped by the container after replacement.

3. The image forming apparatus according to claim 2, wherein
the information indicating the usage history includes identification information of an image forming apparatus to which the container has been mounted.

4. The image forming apparatus according to claim 3, wherein the at least one processor executes instructions in the memory device to
in the case where the replacement is performed, store the identification information of a self-apparatus in the memory of the container after replacement.

5. The image forming apparatus according to claim 2, wherein
the information indicating the usage history includes flag information indicating whether or not the container has entered an out of toner state.

6. The image forming apparatus according to claim 5, wherein the at least one processor executes instructions in the memory device to:
detect a remaining amount of toner of the container in accordance with a sensor equipped by the container mounted to the image forming apparatus; and
in a case where it is detected that the out of toner state has been entered, store the flag information indicating that the out of toner state has been entered in the memory of the container mounted to the image forming apparatus.

7. The image forming apparatus according to claim 1, wherein the at least one processor executes instructions in the memory device to
hold a count value of the cumulative number,
wherein the count value has been set so that initialization of the count value cannot be performed after factory shipment of the image forming apparatus.

8. The image forming apparatus according to claim 1, wherein the at least one processor executes instructions in the memory device to
determine whether or not read and write with respect to a memory equipped by the container after the replacement are possible, and include, in the replacement history, state information indicating whether or not read and write with respect to the memory are possible.

9. The image forming apparatus according to claim 1, wherein
the error history includes information indicating an occurrence location and content of the error that occurred.

10. A method of controlling an image forming apparatus, the method comprising:
forming an image on a sheet by using toner contained in a container mounted to the image forming apparatus;
counting a cumulative number from a time of factory shipment of the image forming apparatus that is a cumulative number of sheets to which image formation is performed;
in a case where a replacement of the container mounted to the image forming apparatus is performed, saving a replacement history that includes the cumulative number for when the replacement was performed and information relating to a container after the replacement; and
in a case where an error occurs in the image forming apparatus, saving an error history that includes the cumulative number for when the error occurred.

11. A non-transitory computer-readable storage medium storing a computer program for causing a computer to execute a method of controlling an image forming apparatus, the method comprising:
forming an image on a sheet by using toner contained in a container mounted to the image forming apparatus;
counting a cumulative number from a time of factory shipment of the image forming apparatus that is a cumulative number of sheets to which image formation is performed;
in a case where a replacement of the container mounted to the image forming apparatus is performed, saving a replacement history that includes the cumulative number for when the replacement was performed and information relating to a container after the replacement; and
in a case where an error occurs in the image forming apparatus, saving an error history that includes the cumulative number for when the error occurred.
